(19) United States
(12) Patent Application Publication
(10) Pub. No.: US 2017/0201531 A1
(43) Pub. Date: Jul. 13, 2017

(54) ABNORMAL BEHAVIOR DETECTION SYSTEM USING QUADRATIC ANALYSIS OF ENTIRE USE BEHAVIOR PATTERN DURING PERSONALIZED CONNECTION PERIOD

(71) Applicant: KOREA INTERNET & SECURITY AGENCY, Seoul (KR)

(72) Inventors: Hwan Kuk KIM, Seoul (KR); Tae Eun KIM, Anyang-si (KR); Chang Min Jo, Seoul (KR); Sa Rang NA, Seongnam-si (KR); Jee Soo JURN, Seoul (KR)

(21) Appl. No.: 15/006,381

(22) Filed: Jan. 26, 2016

(30) Foreign Application Priority Data
Jan. 7, 2016 (KR) 10-2016-0002290

(51) Int. Cl. H04L 29/06

(52) U.S. Cl. CPC H04L 63/1416; H04L 63/0209; H04L 63/1466

(57) ABSTRACT

In order to enhance system security in the BYOD and smart work environment, the abnormal behavior detection system carries out the first analysis for processing situation information into connection, use and agent situation information and profile information and analyzing the entire use behavior pattern during the personalized connection period, and carries out the second analysis based on service access speed to enhance capability for detecting an abnormal behavior.

### CROSS REFERENCE TO RELATED APPLICATION

The present application claims the benefit of Korean Patent Application No. 10-2016-0002290 filed in the Korean Intellectual Property Office on Jan. 7, 2016, the entire contents of which are incorporated herein by reference.

### BACKGROUND OF THE INVENTION

Field of the Invention

The present invention relates to a system for protecting internal resources in a BYOD (Bring Your Own Device) and smart work environment, and, more particularly, to an abnormal behavior detection system in a BYOD and smart work environment.

Background Art

Propagation of internet infra and development of mobile communication bring a significant change which is a revolution in society. Particularly, mobile devices like smart phones are very much ingrained into our lives beyond the meaning of simple communication means. Such a trend has spread to work places, and so, a new working environment by the name of BYOD (Bring Your Own Device) has appeared. The BYOD is a concept to utilize a personal device to work, namely, means all of technology, concept and policy to access to IT resources, such as databases, applications, within an enterprise using personal mobile devices, such as smart phones, lap-top computers, tablet PCs, and so on. From the point of view of enterprises, the BYOD may promote speed, efficiency and productivity of work through more effective business management and reduce financial burdens for supplying business machines because employees can utilize their own personal devices. Accordingly, many enterprises are considering how to successfully introduce the BYOD, and many users have been utilizing personal devices to their business before companies were prepared to apply the BYOD.

The BYOD and smart work environment which is a new IT environment has accelerated construction of wireless internet environment, generalization of smart devices, such as table PCs and smart phones, virtualization of desktop computers, increase of utilization of cloud services, and putting emphasis on business continuity with real-time communication and the likes.

Moreover, with the coming of the BYOD era, infrastructure of companies is being converted from closed environment to open environment. That is, access to enterprise infra by personal devices is authorized anywhere and at any time.

Personal devices can access to enterprise infra through a wireless router (AP), a switch or the like inside companies, and can access to enterprise infra through a mobile communication network, open Wi-Fi, VPN or the likes from the outside of enterprises.

As described above, such changes into open environment cause business continuity and convenience, but may cause lots of security threats that people never expected before. Above all things, due to access of personal devices to enterprise internal infra, internal data of enterprises is at a great risk of leakage. In other words, the internal data of enterprises may be leaked due to a loss or a robbery of the personal devices, and access of the personal devices infected by malicious code to the internal intranet of an enterprise may threaten IT assets of the enterprise.

In order to solve such problems, Korea Internet and Security Agency has implemented an abnormal behavior detection system using the entire use behavior pattern during a personalized connection period (Korean Patent Application No. 10-2015-0000989, hereinafter, called a ‘prior art’).

However, the prior art has a limit in calculating a normal range in the process of detecting a variation of the entire behavior item and a variation of an individual behavior item and deciding whether a user's use behavior is normal or not. Furthermore, the prior art is insufficient and ineffective in the process of deciding whether the user's use behavior is abnormal or not. So, people demand additional analysis algorithm which can compensate the defects of the prior arts and can enhance capacity for detecting an abnormal behavior.

Patent Document 1: Korean Patent Application No. 10-2015-0000989 entitled “Abnormal behavior detection system using entire use behavior pattern during personalized connection period”

### SUMMARY OF THE INVENTION

[11] Accordingly, the present invention has been made to solve the above-mentioned problems occurring in the prior arts, and it is an object of the present invention to provide an abnormal behavior detection system which can process situation information of a BYOD and smart work environment, construct profiles by user and detect an abnormal behavior based on the processed situation information and constructed profiles in order to detect an abnormal access of a device and a real-time abnormal use behavior.

It is another object of the present invention to provide an abnormal behavior detection system for detecting an abnormal behavior using a first analysis, which analyzes behavior frequencies under the same access situation occurring during the entire connection period through analysis of a use behavior pattern of the entire connection period and analyzes the entire use behavior pattern during a personalized connection period, and a second analysis based on service access speed.

Additional features and advantages of the present invention will be shown in the following description, will be apparent by the following description, and will be known well through practice of the present invention. The above and other objects and merits of the present invention will be apparent from the following detailed description of the preferred embodiments of the invention in conjunction with the accompanying drawings.

Differently from the existing network-based security systems through network traffic analysis, the abnormal behavior detection system according to the present invention implemented a method for detecting an abnormal behavior by patterning various behavior elements, such as time, position, connection network and a used device of an object.

Moreover, in order to enhance system security in the BYOD and smart work environment, the abnormal behavior detection system according to the present invention carries out the first analysis for processing situation information into connection, use and agent situation information and profile information and analyzing the entire use behavior pattern during the personalized connection period, and carries out the second analysis based on service access speed to enhance capability for detecting an abnormal behavior.

In order to detect an abnormal access/use behavior, the abnormal behavior detection system according to the present invention utilizes possible atypical data on a business scenario, such as a type of a used device, connection period (for instance, on-duty hours and off-hours), access location (inside the company and outside the company), and a use period of time, as a user behavior pattern, thereby enhancing system security in the BYOD and smart work environment.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is an exemplary view of a BYOD and smart work environment;

FIG. 2 is a block diagram of an abnormal behavior detection system according to the present invention;

FIG. 3 is a block diagram of an abnormality detection unit according to the present invention;

FIG. 4 is a flow chart showing operation of a situation information processing part according to the present invention;

FIG. 5A is a block diagram of a first analysis part for analyzing the entire use behavior according to the present invention;

FIG. 5B is a block diagram of a second analysis part for analyzing the entire use behavior according to the present invention;

FIG. 6 is a block diagram of a use behavior analysis part according to the present invention;

FIG. 7 is a flow chart showing operation of the abnormality detection part according to the present invention;

FIG. 8 is a flow chart showing the second analysis of the entire use behavior by an entire use behavior analysis part according to the present invention;

FIG. 9A is a table of information of past behaviors for analyzing and detecting the entire use behavior pattern during a connection period;

FIG. 9B is a table of information of present situation for analyzing and detecting the entire use behavior pattern during the connection period;

FIGS. 10A and 10B are tables of present situation information for carrying out second analysis of the entire use behavior;

FIGS. 10C and 10D are tables of profile, namely, information of past behaviors, for carrying out the second analysis of the entire use behavior;

FIG. 11 is an exemplary view for analyzing and detecting the entire use behavior pattern during the connection period according to the present invention;

FIG. 12 is a graph showing the present situation information, occurrence probability per past use behavior and an error rate of the probability;

FIG. 13 is an exemplary view showing service usage and connection hours per individual service item;

FIG. 14 is a graph showing N-past profile data;

FIG. 15 is (a) a table showing collected past profile data according to the present invention; and (b) a graph showing a regression line of the profile data table illustrated in (a).

### DETAILED DESCRIPTION OF THE PREFERRED EMBODIMENT

In order to achieve the above-mentioned objects, an abnormality detection part of an abnormal behavior detection system according to the present invention is a device for analyzing a behavior frequency in the same access situation occurring during the entire connection period through use behavior pattern analysis of the entire connection period and detecting an abnormal use behavior, when a predetermined situation information is received from a situation information collection system in a BYOD (Bring Your Own Device) and smart work environment. The abnormal behavior detection system includes: an abnormal behavior analysis module which carries out ‘detection of variation of the entire behavior item’ and ‘detection of variation of an individual behavior item’ using the frequency of use behaviors during the present connection and the average of use behaviors during the past connection through the use behavior pattern analysis procedures of the entire connection period in order to analyze whether use of web service is abnormal or not; a detection demand classifying module which classifies a received detection demand message and transfers the classified message to each analysis part of the abnormal behavior analysis module; and an abnormal behavior detection module which generates information on a detection result of normality or abnormality when the analysis result of the abnormal behavior analysis module is stored and which transfers the generated information to a control system. The abnormal behavior analysis module includes an entire use behavior analysis part which carries out the first analysis for analyzing a use behavior pattern during the entire connection period and carries out the second analysis based on service use speed when the first analysis generates a result value of suspicion.

Preferably, the entire use behavior analysis part includes: a first entire use behavior analysis part for carrying out the first analysis to analyze the use behavior pattern of the entire connection period; and a second entire use behavior analysis part for carrying out the second analysis based on the service use speed when the first entire use behavior analysis part outputs a result value of suspicion.

Preferably, the first entire use behavior analysis part includes: a use behavior inquiry part for inquiring use processing information; a first frequency analysis part for detecting frequencies of use behaviors occurring during the entire connection period from the present processing information; a profile inquiry part for inquiring past profile information of the corresponding user; a second frequency analysis part for detecting frequencies of user behaviors under the same access situation as the past; and a use behavior comparing part which calculates an error value by each behavior and judges whether or not the present user's behavior is normal according to the calculated error value in order to carry out ‘detection of variation of the entire behavior item’, and judges whether or not the present user's behavior is abnormal as variation by individual item in order to carry out ‘detection of variation of the individual behavior item’.

Preferably, the second entire use behavior analysis part includes: a service use frequency detection part for detecting the number of the present user's service use behaviors; a service use time detection part for detecting the present user's service use time; a past service use frequency inquiry part for detecting the user's past service use time by loading the profile data stored in a storing part; and a use behavior analysis part which compares the present service use speed with the past service use speed through regression analysis and judges whether the present user's use behavior is normal or not.

Preferably, the use behavior analysis part includes: a data collection part for collecting N-past profile data; a regression line generating part for generating a regression line of the collected profile data; a normal range setting part which obtains an average residual r based on the regression line and sets a normal range of a residual (rᵢ) between the present service use speed and the past service use speed; a use speed comparing part which obtains a residual rᵢ and checks whether the residual belongs to the normal range or not; and a normality judging part which judges normality or abnormality of the present user's use behavior according to whether the residual rᵢ belongs to the normal range.

In order to achieve the above-mentioned objects of the present invention, a method for detecting abnormality of the abnormality detection part according to the present invention relates to a method for analyzing frequencies of behaviors under the same access situation occurring during the entire connection period through the use behavior pattern analysis of the entire connection period and detecting an abnormal use behavior when a predetermined situation information is received from the situation information collection system in a BYOD (Bring Your Own Device) and smart work environment.

The method for detecting abnormality includes: a process that the detection demand classifying module classifies received detection demand messages and transfers the classified messages to each analysis part of the abnormal behavior analysis module; a process that the abnormal behavior analysis module analyzes abnormality of the web service use by carrying out ‘detection of error value variation of the entire behavior item’ and ‘detection of error value variation of the individual behavior item’ using the frequency of use behaviors during the present connection and the average of use behaviors during the past connection through the first entire use behavior analysis for analyzing the use behavior pattern of the entire connection period; and a process that the abnormal behavior detection module generates information of the detection result of normality or abnormality when the analysis result of the abnormal behavior analysis module is stored and transfers the generated information to the control system. The abnormal behavior analysis module carries out the second analysis of the entire use behavior based on service use speed when the first analysis of the entire use behavior generates a result value of suspicion.

Hereinafter, Reference will be now made in detail to the preferred embodiments of the present invention with reference to the attached drawings. The example embodiments which will be described later are provided to make those skilled in the art easily understand the present invention. In the drawings, similar reference numerals have similar or the same functions in various aspects.

A BYOD and smart work service can analyze situation information of a user who accesses/uses an internal service of an enterprise, judge whether or not the user's behavior is abnormal in real time, and control the corresponding user's access and use if necessary. The abnormal behavior detection system according to the present invention judges whether or not the user's behavior is abnormal based on previously accumulated normal profile or previously established security policies and the present occurring behavior.

The situation information means information related with a user's connection, use and termination which are collected in the collection system and transferred to the abnormal behavior detection system. The profile is a set of information that identifies the user and quantifies the user's behavior, and is the information that information on the user has been accumulated and patterned from the past. Profiling is a series of behaviors for profile management, such as generation, correction, deletion and storing of profiles.

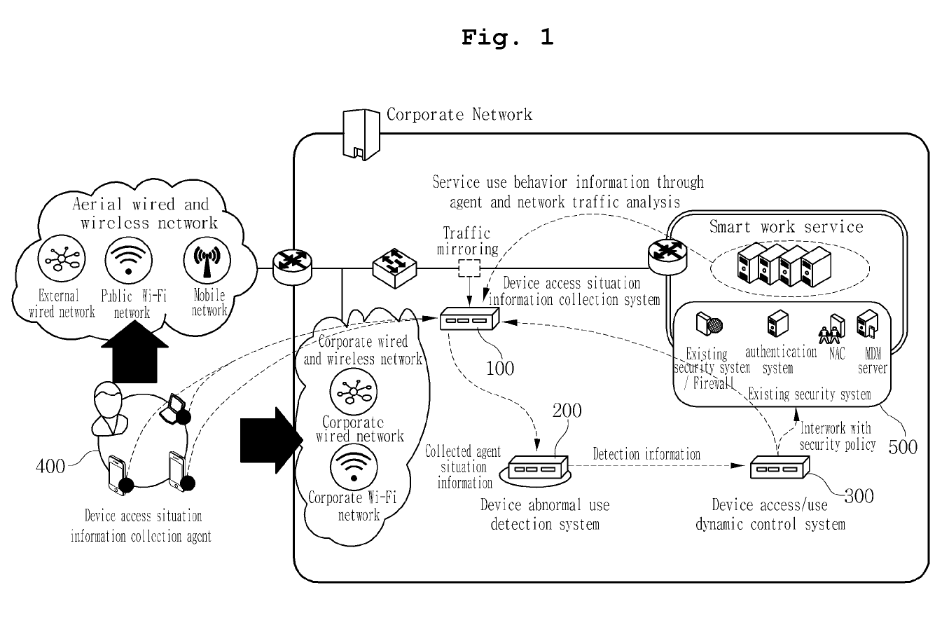

FIG. 1 is an exemplary view showing a BYOD and smart work environment.

As shown in FIG. 1, the BYOD and smart work environment is configured to have a situation information collection system 100, an abnormal behavior detection system 200, a control system 300, a personal device 400 and a security system 500, such as an MDM server or an NAC server.

The situation information collection system 100 collects relevant situation information when the personal device 400 and an MDM agent device is authorized, is accessed and terminates connection.

In this instance, collected situation information contains connection address (ID, post, authority, present status, and so on), connection pattern (authentication result, the number of authentication failures, and so on), network behavior information (connection time, position, and so on), and connection termination time information. Such situation information exits as periodic transmission data and non-periodic (real-time) transmission data, but the situation information collection system 100 regards all of the data as non-periodic transmission data and collects the data.

Next, the abnormal behavior detection system 200 includes a situation information receiving part, a situation information processing part and an abnormal behavior detection part. As shown in FIG. 1, the abnormal behavior detection system 200 carries out detection of an abnormal behavior by receiving situation information from the situation information collection system 100, and then, transfers a detected result to the control system 300, such as a dynamic access control middleware.

The abnormal behavior detection system 200 classifies the situation information received from the situation information collection system 100 by service access session, processes the situation information as occasion demands, and generates additional information, such as access ID, creation of device ID, and information oN-past behavior pattern. Moreover, the abnormal behavior detection system 200 patterns the accumulated data by user ID in order to generate and update profiles. Processing information of a user who accesses and uses services judges abnormality based on security policies and normal profile of the corresponding user. The detection result of the system is transferred to the control system 300 in real time.

The control system 300 receives abnormal behavior information detected in the abnormal behavior detection system 200 to control through a control GUI or establish and manage security policies, and interworks with an external security device. Such a control system 300 is connected with the abnormal behavior detection system 300 and the external security device, for instance, GENIAN and WAPPLES.

The personal device 400 is a personal mobile device, such as a smart phone, a lap-top computer and a tablet PC, and can access to IT resources inside an enterprise, such as database and applications inside the enterprise, and a user deals with business through the personal device 400.

The personal device 400 generates situation information when the personal device 400 is authorized, is accessed and terminates connection. In this instance, the situation information is the same as described above.

The security system 500 is located at a DMZ or a screened subnet and performs function as a gateway for communication, such as authentication connection between corporate network and the personal device 400, direct push update and so on. A number of agents access to the security system 500 to generate the above-mentioned situation information.

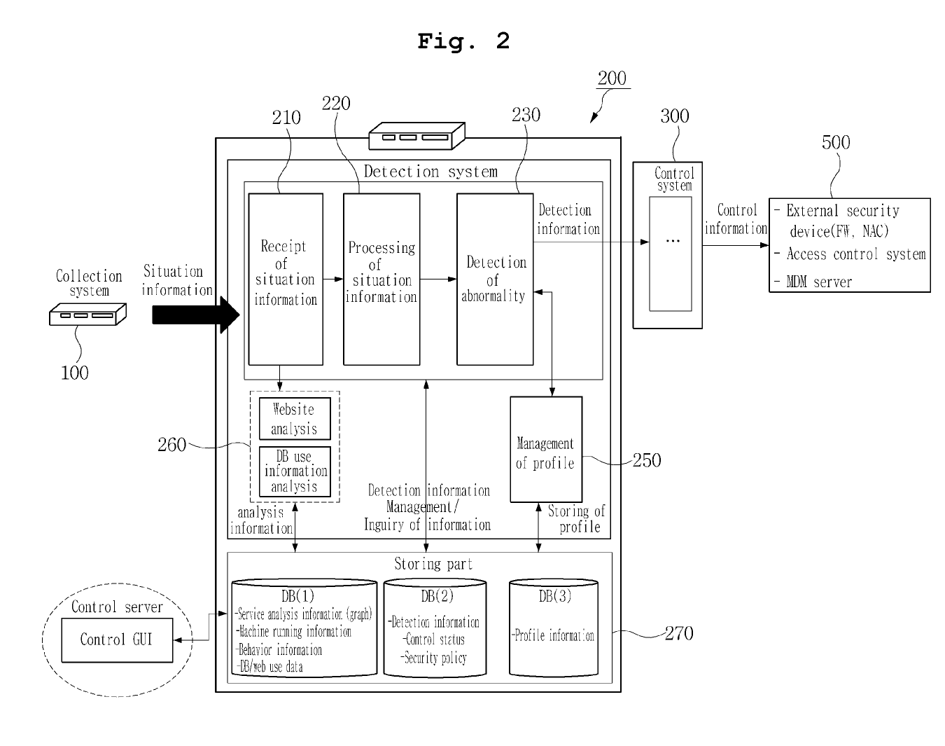

FIG. 2 is a block diagram of the abnormal behavior detection system according to the present invention.

As shown in FIG. 2, the abnormal behavior detection system 200 according to the present invention includes a situation information receiving part 210, a situation information processing part 220, an abnormality detection part 230, a profile managing part 250, an information analysis part 260, and a storing part 270.

The situation information receiving part 210 receives information on a user's various situations, such as ‘network access’, ‘service use’ and ‘termination of connection’, from the situation information collection system 100 separated physically, and transfers the received information to the situation information processing part 220 and the information analysis part 260.

All of the received situation information is transferred to the situation information processing part 220, but use situation information, such as information on web service use demand/response, information on DB SQL Batch demand/response, and information on DB RPC demand/response, is transferred to the information analysis part 260. The information analysis part 260 receives the use situation information and carries out website analysis and DB use information analysis.

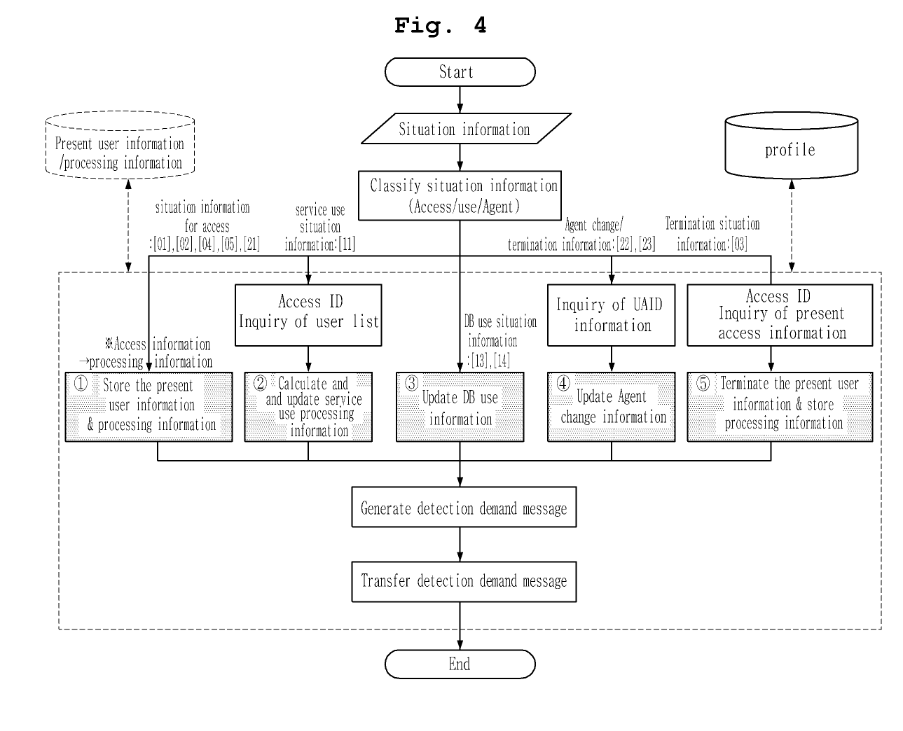

As shown in FIG. 4, the situation information processing part 220 classifies and processes the situation information data received from the situation information collection system 100, and then stores the processed data by the user's connection session.

The situation information processing part 220 receives and processes the situation information, such as ‘network connection’, ‘service use’ and ‘termination of connection’, received through the situation information receiving part 210, and then, stores the processed situation information in a temporary storage space located at one side of the storing part 270. In this instance, the temporary storage space may be in the form of a DB, a file or a memory.

The situation information processing part 220 combines and processes the situation information based on the connection ID and stores the processing information in the temporary storage space, and the detection module uses the processing information. The connection ID is combination of a connection address and a session ID.

The situation information processing part 220 adds connection information or carries out an update process according to whether or not there are authentication result and the user's connection information if situation information related with ‘network connection’ is received. As the situation information related with ‘network connection’, there are success of general authentication, failure of general authentication, intensified authentication, agent installation authentication, agent access information, and so on.

The situation information processing part 220 updates service use information based on the same connection ID when the situation information related with ‘service use’ is received.

Furthermore, when the situation information related with ‘DB use’ is received, the situation information processing part 220 updates the corresponding information to the processing information. Additionally, when the situation information related with ‘agent change’ is received, the situation information processing part 220 inquires UAID and updates the information to the user's processing information which coincides with the corresponding information. In addition, when the situation information related with ‘termination of connection’ is received, the situation information processing part 220 updates termination of the present connection ID and connection termination time.

After that, when all the situation information is received, the situation information processing part 220 generates a detection demand message and transfers the message to the abnormality detection part 230.

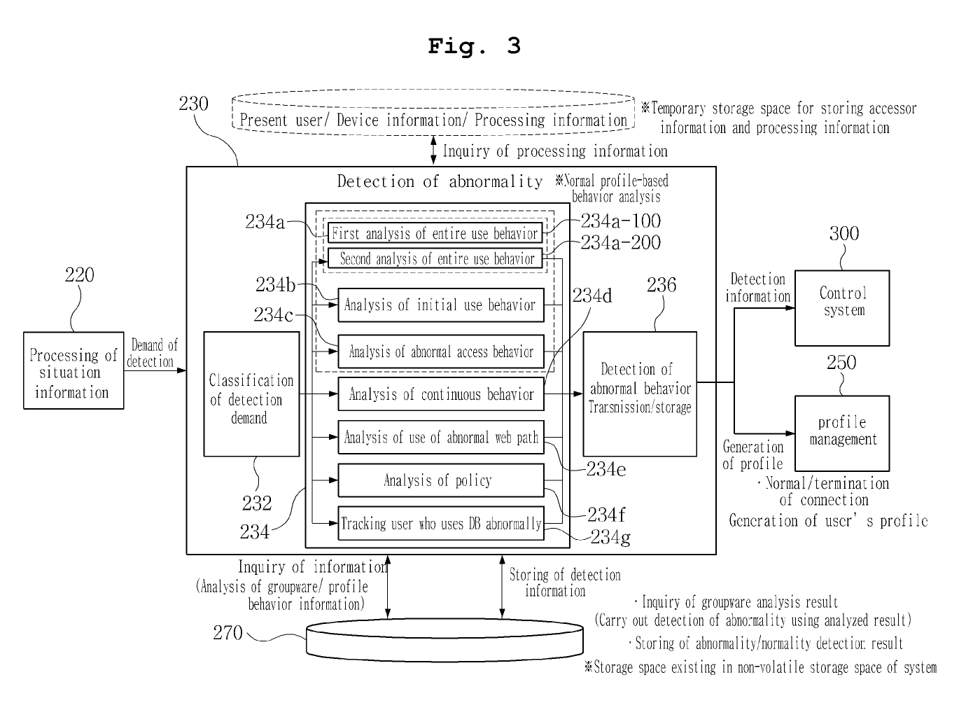

The abnormality detection part 230 is a device for classifying the detection demand message and analyzing and detecting an abnormal behavior related with the user's network use. As shown in FIG. 3, the abnormality detection part 230 includes a detection demand classifying module 232, an abnormal behavior analysis module 234, and an abnormal behavior detection module 236. FIG. 3 is a block diagram of an abnormality detection part according to the present invention.

When situation information of various kinds is inputted, the detection demand classifying module 232 classifies the detection demand message and transfers the message to analysis parts 234a to 234g of the abnormal behavior analysis module 234 to carry out analysis.

The abnormal behavior analysis module 234 is a module to analyze various abnormal behaviors, and includes normal profile-based behavior analysis parts 234a, 234b and 234c, a continuous behavior analysis part 234d, an abnormal web use analysis part 234e, a policy analysis part 234f, and a user tracking part 234g. The analysis parts 234a to 234g of the abnormal behavior analysis module 234 carry out different analyses of information according to kinds of the situation information inputted.

The normal profile-based behavior analysis parts 234a, 234b and 234c compare the entire use behavior, the initial use behavior and abnormal connection behavior during the connection period with analysis values of the past normal profile information, and then, analyze different points between abnormal behaviors and normal behaviors.

As shown in FIG. 3, the normal profile-based behavior analysis parts 234a, 234b and 234c are an entire use behavior analysis part 234a, an initial use behavior analysis part 234b and an abnormal access behavior analysis part 234c, and compare a pattern of the entire use behavior during the connection period, a pattern of the initial use behavior and a pattern of the abnormal access behavior with the analysis values of the past normal profile information, and then, analyze different points between the abnormal behaviors and the normal behaviors.

As shown in FIG. 3, the entire use behavior analysis part 234a out of the normal profile-based behavior analysis parts 234a, 234b and 234c includes: a first entire use behavior analysis part 234a-100 which carries out a pattern analysis (first analysis) of the entire use behavior during the connection period; and a second entire use behavior analysis part 234a-200 which carries out a second analysis based on service use speed if the first entire use behavior analysis part 234a-100 outputs a result value of suspicion.

The continuous behavior analysis part 234d analyzes whether the use situation information continuously inputted from the present connection session repeatedly carries out the same behavior.

The abnormal web use analysis part 234e compares the user's previous service use page with an URI of the present input use situation information through the structure of the previously analyzed service web site, and then, analyzes an abnormal behavior inaccessible by the user's behavior.

The policy analysis part 234f judges whether the processing information and profile of the user, who is in connection and use, is abnormal or not. The policy analysis part 234f judges normality and abnormality on the basis of the previously established security policy as judging criteria.

The security policy established by an administrator includes a series of conditions (criteria) and control results applied when the conditions are accorded. The security policy of a system to be developed is established using kinds of information which is used for forming the user's processing information and profile information.

The user tracking part 234g tracks a user, who a may make an abnormal behavior, using DB-query generation information which has been previously made when an abnormal behavior is detected by the security policy in which DB use situation information is set.

When an analysis value of the behavior is stored from the abnormal behavior analysis module 234, the abnormal behavior detection module 236 judges whether the analysis value of the behavior is abnormal or not, generates detection information, and transfers the detection information to the control system 300. If an abnormal behavior is not detected when situation information of user connection determination is inputted, the abnormal behavior detection module 236 sends a profile generation message to the profile managing part 250. Moreover, the profile managing part 250 generates profile of normal/connection termination.

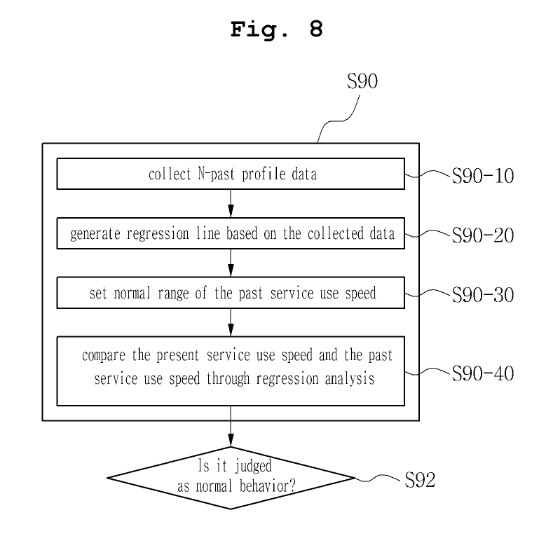

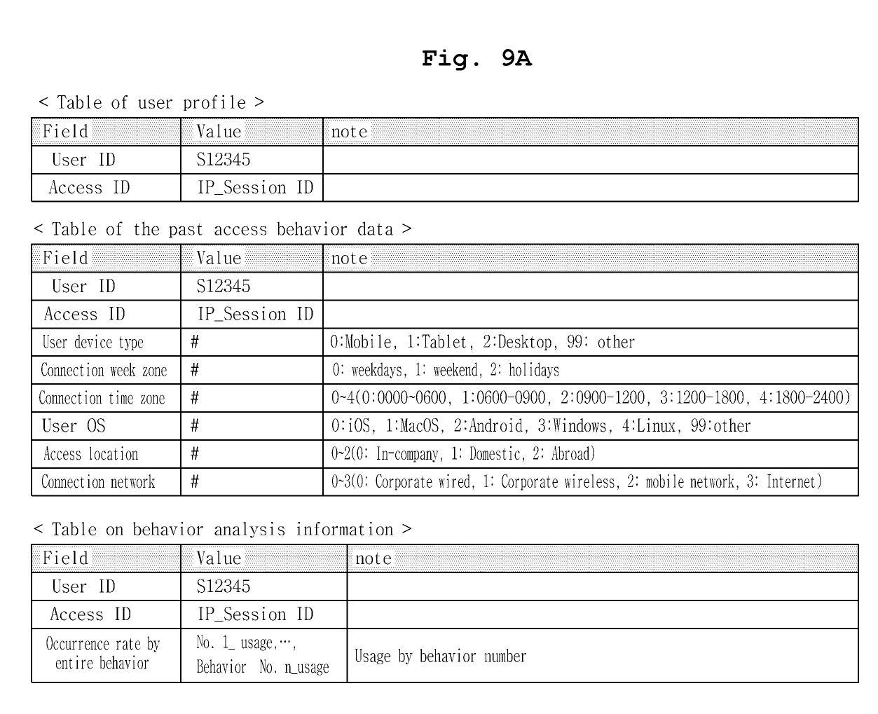

As shown in FIG. 8, the profile managing part 250 generates profile information by profiling the situation information of various use behaviors of the user, and then, stores and manages the profile information.

When the situation information receiving part 210 receives the user's information of various situations, such as ‘network connection’, ‘service use’, ‘termination of connection’ and so on, the information analysis part 260 analyzes web site and DB use information through the received situation information.

Next, the storing part 270 stores the information, which is processed into connection, use and agent situation information, and the profile information. The situation information collected by the situation information collection system 100 is processed into connection, use and agent situation information, and the situation information at the time of termination of connection is processed into profile information, and then, is stored in the storing part 270.

In this instance, the stored profile information includes user profile, terminal device profile, access behavior profile, and use behavior. The user profile contains user authority information, the number of total authentication failures, the recent access date, the initial access date, total service hours and the number of times of access, the terminal device profile contains ID, type, OS, browser, name, MAC, whether or not an agent is installed, whether or not a screen is locked, installation program information, automatic login setting, and the recent access date. Furthermore, the access behavior profile contains access behavior pattern information.

FIG. 4 is a flow chart showing operation of a situation information processing part according to the present invention.

As shown in FIG. 4, the situation information processing part 220 according to the present invention classifies the situation information by code, processes the situation information, and stores the processing information in the temporary storage space. The situation information inputted through the situation information receiving part 210 is classified by each situation information because having different types, and is stored on the basis of information which can identify the user, such as access ID, user ID, UAID and so on.

In case of the situation information of ‘access’, the situation information processing part 220 creates new access if the present access information does not exist, but the corresponding information is updated if there is information on the existing access.

In case of the situation information of ‘service use’, the situation information processing part 220 finds the session, which is in connection, on the basis of the access ID, updates service use information, and calculates relevant behavior analysis information.

Additionally, in case of the situation information of ‘DB use’, the situation information processing part 220 continuously stores the situation information in the storage space until the corresponding information is utilized, and deletes an old list above a predetermined period.

In addition, in case of the situation information of ‘agent change/termination’, the situation information processing part 220 searches a user who has the corresponding UAID and updates change information.

Moreover, in case of the situation information of ‘termination’, the situation information processing part 220 terminates connection of the corresponding access ID and updates processing information.

Next, the entire use behavior analysis part 234a according to the present invention will be described.

The entire use behavior analysis part 234a according to the present invention is a device for first and second analyzing patterns of the entire use behaviors during the connection period, and includes a first entire use behavior analysis part 234a-100 and a second entire use behavior analysis part 234a-200.

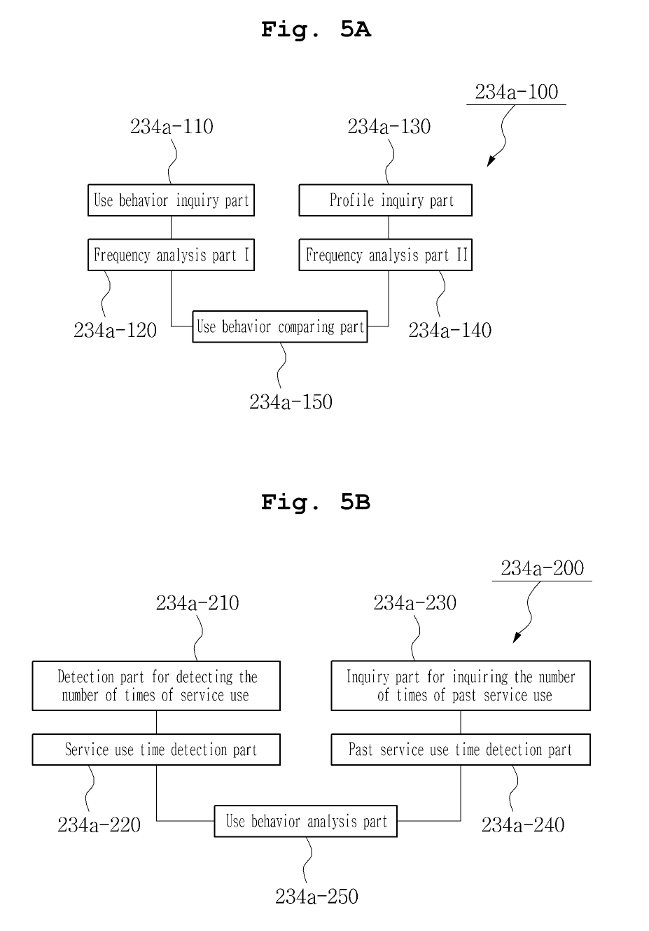

FIG. 5A is a block diagram of a first analysis part for analyzing the entire use behavior according to the present invention.

As shown in FIG. 5A, the first entire use behavior analysis part 234a-100 according to the present invention includes a use behavior inquiry part 234a-110, a first frequency analysis part 234a-120, a profile inquiry part 234a-130, a second frequency analysis part 234a-140, and a use behavior comparing part 234a-150. The first entire use behavior analysis part 234a-100 carries out pattern analysis (first analysis) of the use behaviors of the entire connection period.

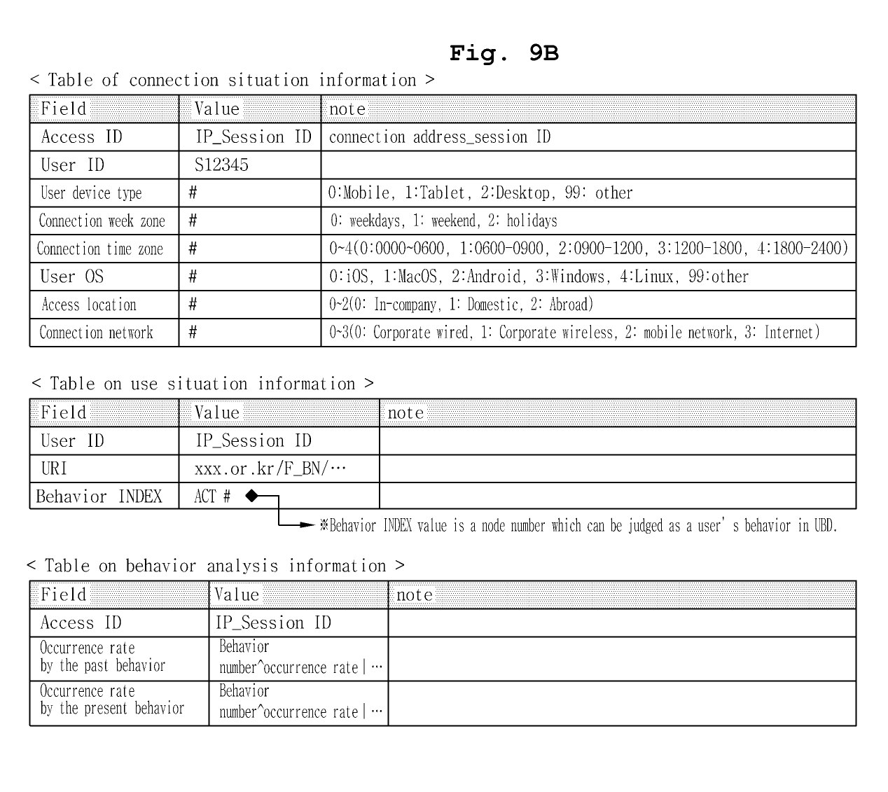

When a detection demand message is received from the situation information processing part 220, the profile inquiry part 234a-130 inquires the corresponding user's past profile information referring to the table on the past behavior information shown in FIG. 9A. FIG. 9A is a table on profile for analyzing and detecting a pattern of the entire use behavior during the connection period, namely, the past behavior information.

Moreover, the second frequency analysis part 234a-140 detects the frequency of the user behavior in the same connection situation as the past from the inquired past profile information.

The use behavior inquiry part 234a-110 inquires the present user's use processing information referring to the table of the present situation information. FIG. 9B is a table of the present situation information for analyzing and detecting the pattern of the entire use behavior during the connection period.

The first frequency analysis part 234a-120 detects frequency of use behaviors during the entire connection period from the processing information on the present use of the user which is inquired.

The use behavior comparing part 234a-150 calculates an error value by behavior and judges whether or not the present user's use behavior is abnormal according to the calculated error value in order to carry out the ‘variation detection of the entire behavior item’, and judges whether or not the present user's use behavior is abnormal using the variation by individual behavior item in order to carry out the ‘variation detection of individual behavior item’.

The use behavior comparing part 234a-150 first calculates the error value per behavior as shown in the following equation 1 in order to carry out the ‘variation detection of the entire behavior’.

Error value=(present use behavior #1−past use behavior #1)²+ . . . +(present use behavior #n−past use behavior #n)² [Equation 1]

Moreover, the calculated error value is compared with the sum of (individual item N% of the past behavior information)̂2. If the calculated error value is smaller than or the same as the sum of individual item N % of the past behavior information̂2, the use behavior comparing part 234a-150 judges the present user's use behavior as normality. If the calculated error value is larger than the sum of individual item N % of the past behavior information̂2, the use behavior comparing part 234a-150 judges the present user's use behavior as abnormality.

Furthermore, in order to carry out the ‘variation detection of the individual behavior item’, the use behavior comparing part 234a-150 compares variations by individual items. The individual item means a deviation value of an individual behavior part which is calculated in a middle stage in order to obtain the entire behavior deviation.

The use behavior comparing part 234a-150 judges that the present user's use behavior is normal if the variation by individual item is less than X %, and then, stores the judged result (analysis result). The use behavior comparing part 234a-150 judges that the present user's use behavior is abnormal if the variation by individual item is larger than X %. In this instance, the default value of X is 30.

FIG. 5B is a block diagram of the second entire use behavior analysis part for analyzing the entire use behavior according to the present invention.

As shown in FIG. 5B, the second entire use behavior analysis part 234a-200 according to the present invention is a device for carrying out second analysis based on service use speed if the result value of the first analysis of the entire use behavior is suspected of abnormality, and includes a detection part for detecting the number of times of service use 234a-210, a service use time detection part 234a-220, an inquiry part for inquiring the number of times of past service use 234a-230, a past service use time detection part 234a-240, and a use behavior analysis part 234a-250.

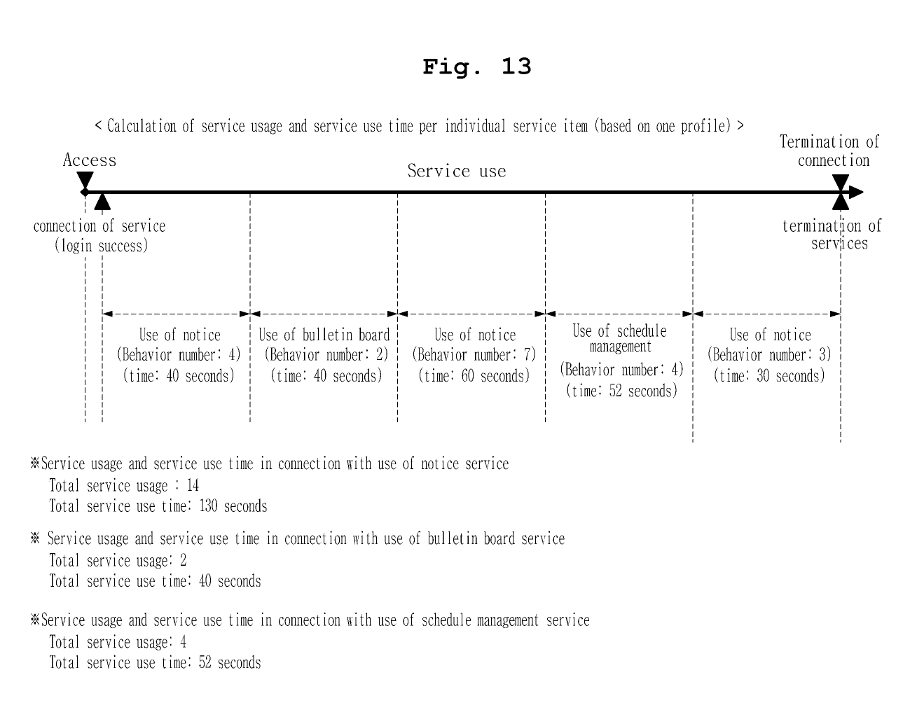

The detection part for detecting the number of times of service use 234a-210 detects how many the present user has used services. The number of service use behaviors means the number of times of services used from access to termination of connection. In FIG. 13, the number of notice service use behaviors is total 14, the number of bulletin board service use behaviors is 2, and the number of schedule management service use behaviors is 4. FIG. 13 shows service usage and use period per individual service item.

The service use time detection part 234a-220 detects the present user's service use time. The service use time means a service use period from access to termination of use. In FIG. 13, the notice service use period is total 130 seconds, the bulletin board service use period is 40 seconds, and the schedule management service use period is 52 seconds.

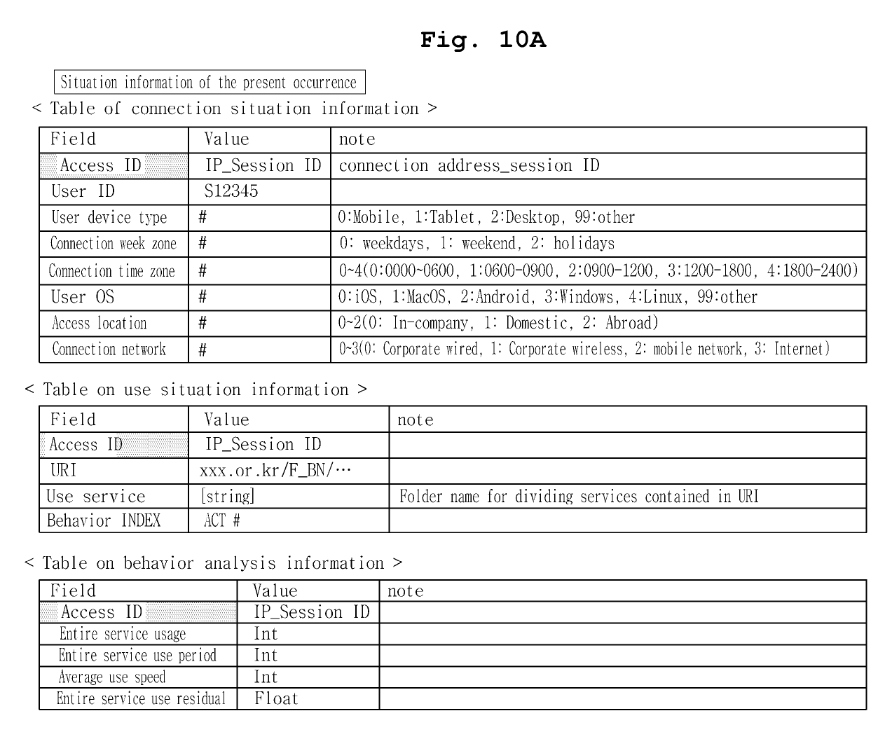

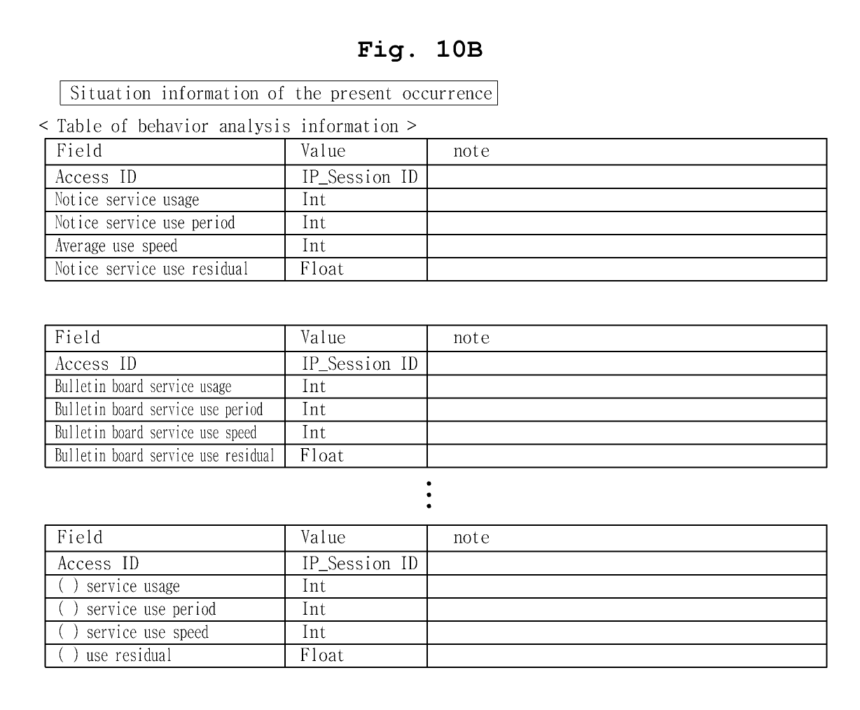

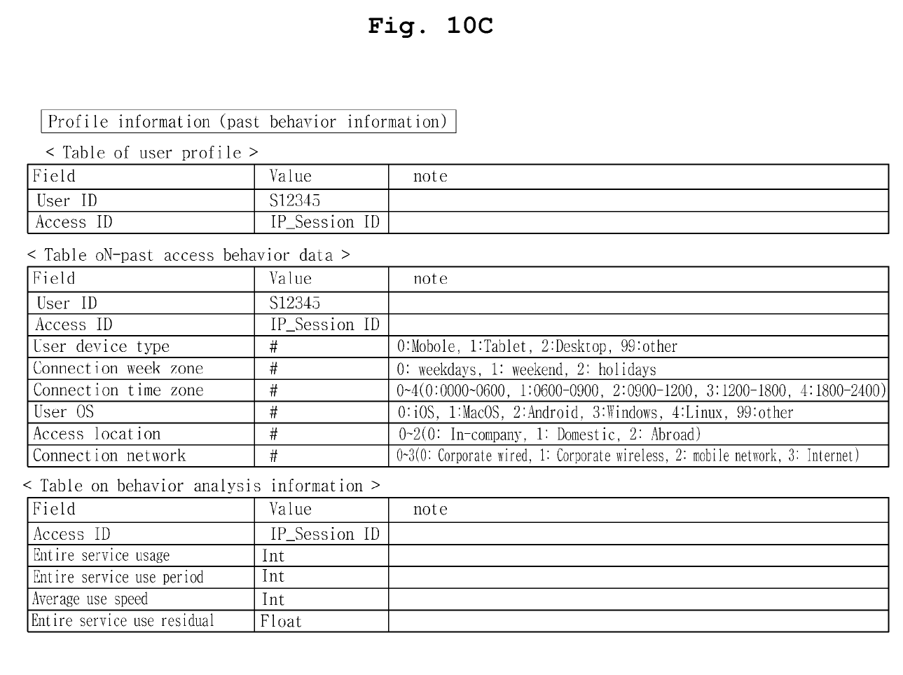

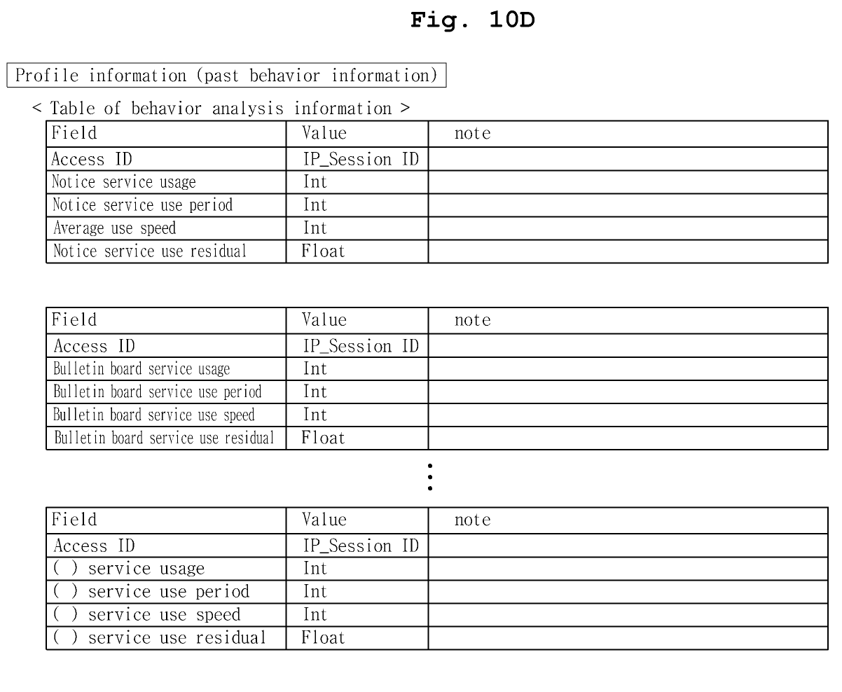

The detection part for detecting the number of times of service use 234a-210 and the service use time detection part 234a-220 detect the number of the present user's service use behaviors and the present user's service use time referring to the table on the present situation information shown in FIGS. 10A and 10B.

FIGS. 10A and 10B are tables of present situation information for carrying out second analysis of the entire use behavior.

As shown in FIGS. 10C and 10D, the inquiry part for inquiring the number of times of past service use 234a-230 loads the profile data stored in the storing part 270 to detect the number of times of the user's past service use behaviors.

As shown in FIGS. 10C and 10D, the past service use time detection part 234a-240 loads the profile data stored in the storing part 270 to detect the number of the user's past service use time.

FIGS. 10C and 10D are tables of profile, namely, information of past behaviors, for carrying out second analysis of the entire use behavior.

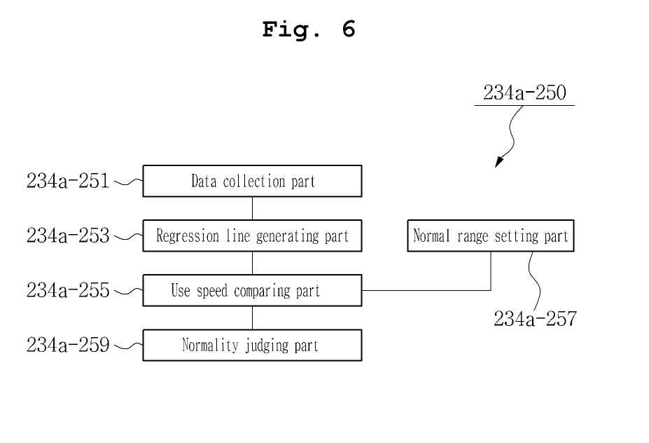

As shown in FIG. 6, the use behavior analysis part 234a-250 includes a data collection part 234a-251, a regression line generating part 234a-253, a use speed comparing part 234a-255, a normal range setting part 234a-257, and a normality judging part 234a-259. The use behavior analysis part 234a-250 compares the present service use speed with the past service use speed through regression analysis and judges whether or not the present user's use behavior is normal. FIG. 6 is a block diagram of the use behavior analysis part according to the present invention.

The data collection part 234a-251 collects N-past profile data.

The data collection part 234a-251 refers to the profile data inquired by the inquiry part for inquiring the number of times of past service use 234a-230 and the past service use time detection part 234a-240. The data collection part 234a-251 detects N-past profile data, for instance, the number of the user's past service use behaviors and the user's past service use time, which were stored the last, out of the inquired profile data.

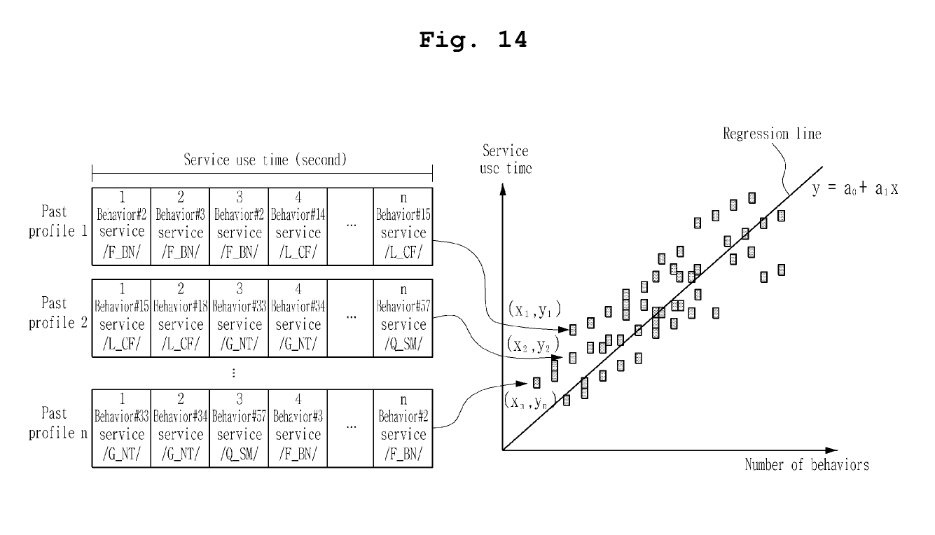

FIG. 14 is a graph showing N-past profile data.

As shown in FIG. 14, in the graph of the profile data, the number of service use behaviors is plotted along the X-axis and the service use time is plotted along the Y-axis, and the user's N-past profile data are respectively indicated as dots.

The regression line generating part 234a-253 generates a regression line of the N-past profile data in order to analyze the user's use speed. In this instance, the regression line generating part 234a-253 generates the regression line referring to the following equation 2.

$$y = {a}_{0} + {a}_{1} x \\ {a}_{1} = \frac{n {\sum }_{i = 1}^{n} {x}_{i} {y}_{i} - {\sum }_{i = 1}^{n} {x}_{i} {\sum }_{i = 1}^{n} {y}_{i}}{n {\sum }_{i = 1}^{n} {x}_{i}^{2} - {( {\sum }_{i = 1}^{n} {x}_{i} )}^{2}} \\ {a}_{0} = \frac{{\sum }_{i = 1}^{n} {y}_{i}}{n} - {a}_{1} \frac{{\sum }_{i = 1}^{n} {x}_{i}}{n} , \qquad [ Equation 2 ]$$

In the above equation, n means the number of profiles of a user to whom regression analysis will be applied. If n is 100, the regression line generating part 234a-253 generates a regression line utilizing information of 100 profiles.

The normal range setting part 234a-257 obtains an average residual r based on the generated regression line, for instance, y=a₀+a₁x, and sets a normal range of the residual (rᵢ), for instance, |rᵢ|>|r|.

The use speed comparing part 234a-255 compares the present service use speed with the past service use speed through regression analysis using the generated regression line, for instance, y=a₀+a₁x. The use speed comparing part 234a-255 obtains the residual rᵢ between the present service use speed and the past service use speed, and checks whether or not the residual belongs to the normal range |rᵢ|>|r|.

As a check result of the use speed comparing part 234a-255, if the residual rᵢ belongs to the normal range |rᵢ|>|r|, the normality judging part 234a-259 judges the present user's use behavior as normality. However, if the residual rᵢ does not belong to the normal range |rᵢ>|r|, the normality judging part 234a-259 judges the present user's use behavior as abnormality.

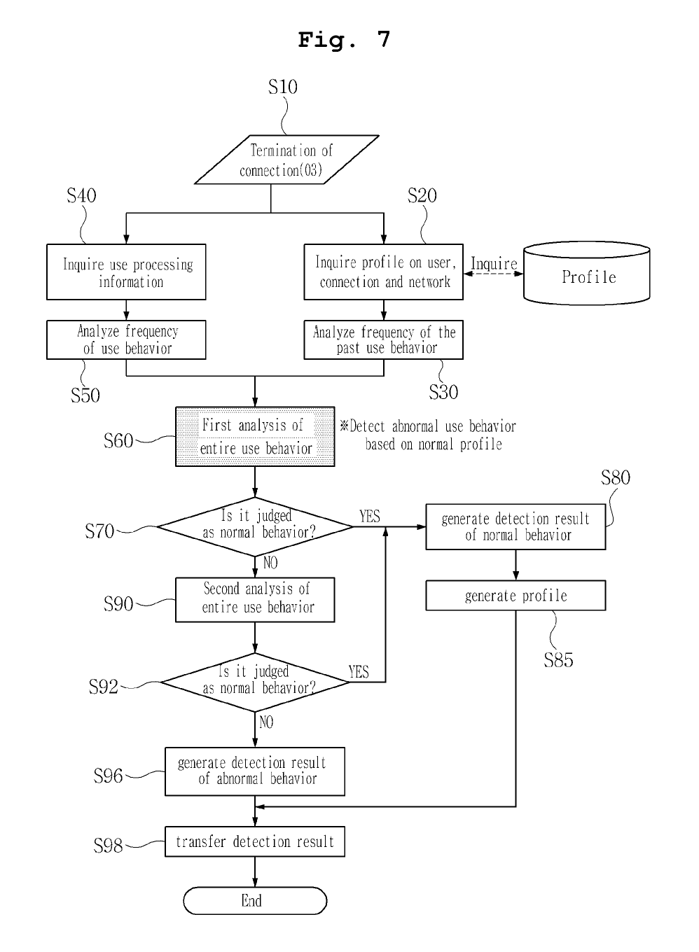

FIG. 7 is a flow chart showing operation of the abnormality detection part according to the present invention. Especially, the abnormality detection part relates to analysis of the pattern of the entire use behavior during the connection period by the normal profile-based behavior analysis part.

The abnormality detection part 230 according to the present invention is a device which classifies the detection demand message and analyzes and detects an abnormal behavior related with the user's network use, and includes a detection demand classifying module 232, an abnormal behavior analysis module 234, and an abnormal behavior detection module 236.

Out of them, the abnormal behavior analysis module 234 is a module for analyzing patterns of various abnormal behaviors, and includes a continuous behavior analysis part 234d, an abnormal web use analysis part 234e, a policy analysis part 234f, and a user tracking part 234g.

The normal profile-based behavior analysis parts 234a, 234b and 234c compare the pattern of the entire use behavior, the pattern of the initial use behavior and the pattern of the abnormal access behavior with analysis values of the normal profile information, and then, analyze different points between abnormal behaviors and normal behaviors.

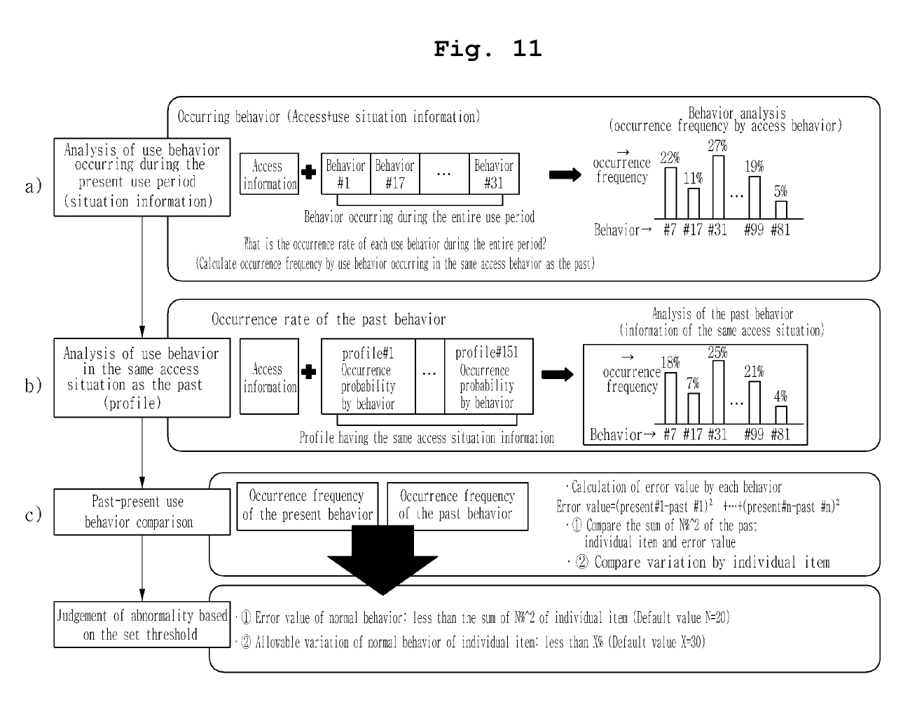

When the situation information of ‘termination (connection termination)’ is inputted to the abnormal behavior detection system 200 and a detection demand message is received from the situation information processing part 220, as shown in b) of FIG. 11, the entire use behavior analysis part 234a inquires the corresponding user's past profile information to analyze the frequency of behaviors in the same access situation (S10 to S30).

FIG. 11 is an exemplary view for analyzing and detecting the pattern of the entire use behavior during the connection period according to the present invention, namely, showing operation for the first analysis of the entire use behavior by the entire use behavior analysis part 234a.

Additionally, as shown in a) of FIG. 11, the entire use behavior analysis part 234a inquires use processing information, and then, analyzes the frequency of the use behaviors during the entire connection period in the present processing information (S40 to S50).

After that, as shown in c) of FIG. 11, the entire use behavior analysis part 234a carries out ‘detection of variation of the entire behavior item’ and ‘detection of variation of an individual behavior item’ using the frequency of use behaviors during the present connection and the average of use behaviors during the past connection to judge an abnormal behavior (S60), and it is called the first entire use behavior analysis.

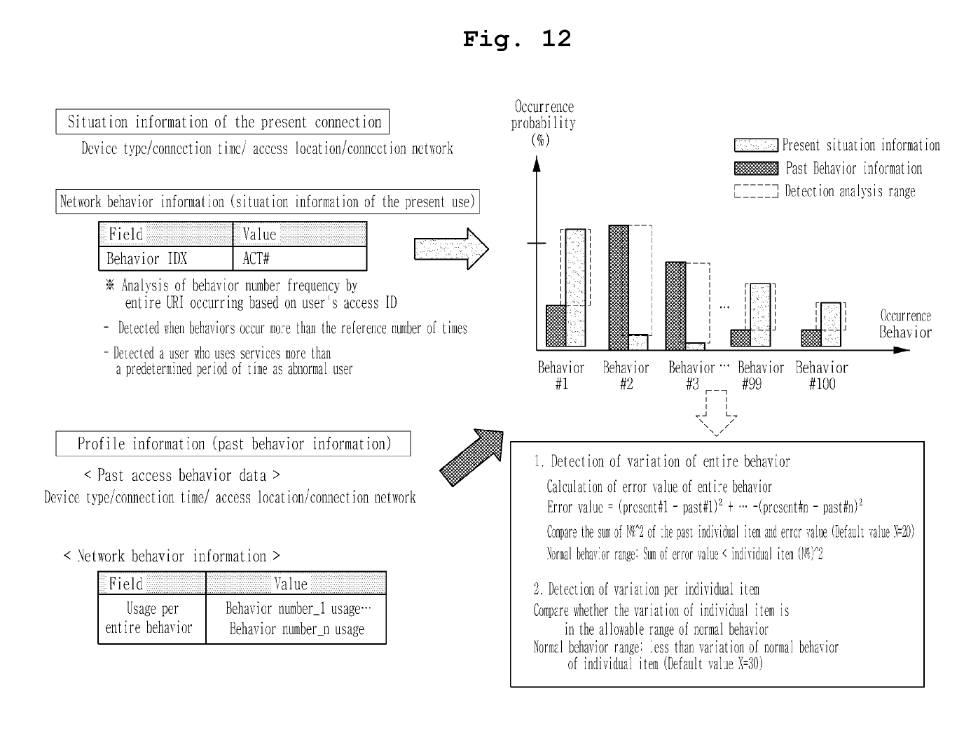

The entire use behavior analysis part 234a first calculates an error value per each behavior in order to carry out the ‘variation detection of the entire behavior’. FIG. 12 is a graph showing the present situation information, occurrence probability per the past use behaviors and error rates.

Error value=(present use behavior #1−past use behavior #1)²+ . . . +(present use behavior #n−past use behavior #n)² [Equation 1]

Moreover, the calculated error value is compared with the sum of (individual item N % of the past behavior information)̂2. If the calculated error value is smaller than or the same as the sum of individual item N % of the past behavior information̂2, the entire use behavior analysis part 234a judges the present user's use behavior as normality. If the calculated error value is larger than the sum of individual item N % of the past behavior information̂2, the entire use behavior analysis part 234a judges the present user's use behavior as abnormality.

Furthermore, in order to carry out the ‘variation detection of the individual behavior item’, the entire use behavior analysis part 234a compares variations by individual items. The individual item means a deviation value of an individual behavior part which is calculated in a middle stage in order to obtain the entire behavior deviation.

The entire use behavior analysis part 234a judges that the present user's use behavior is normal if the variation by individual item is less than X %, and then, stores the judged result (analysis result). The entire use behavior analysis part 234a judges that the present user's use behavior is abnormal if the variation by individual item is larger than X %.

If all of the ‘detection of variation of the entire behavior item’ and ‘detection of variation of an individual behavior item’ show normal result values, the present invention finally judges the user's use behavior as normality. However, if any one of the ‘detection of variation of the entire behavior item’ and ‘detection of variation of an individual behavior item’ shows a result value of abnormality, the entire use behavior analysis part 234a outputs a result value of ‘suspicion’ and carries out procedures for additional analysis (second analysis of the entire use behavior).

If all of the ‘detection of variation of the entire behavior item’ and ‘detection of variation of an individual behavior item’ show normal result values, the abnormal behavior detection module 236 generates a detection result of normal behavior and generates the corresponding profile (S70 to S85).

In addition, if any one of the ‘detection of variation of the entire behavior item’ and ‘detection of variation of an individual behavior item’ shows a result value of abnormality, the entire use behavior analysis part 234a suspects the user's use behavior and carries out the second analysis of the entire use behavior based on service use speed (S90).

FIG. 8 is a flow chart showing the second analysis of the entire use behavior of the entire use behavior analysis part according to the present invention.

When the second analysis of the entire use behavior starts, as shown in FIG. 8, the entire use behavior analysis part 234a according to the present invention collects N-past profile data (S90-10).

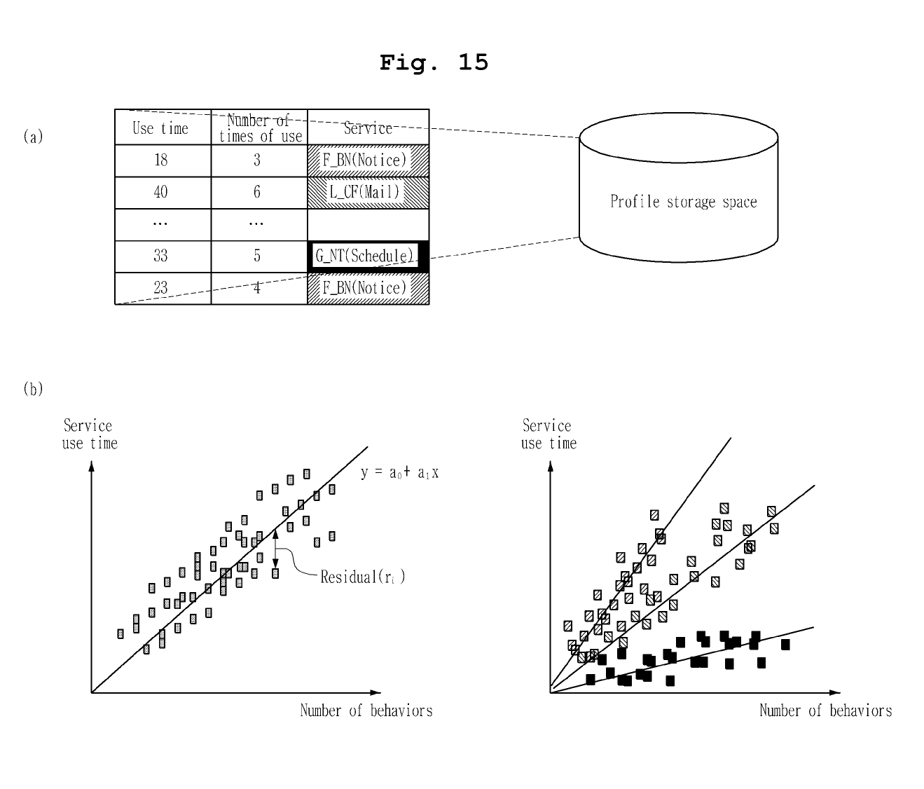

As shown in (a) of FIG. 15, the entire use behavior analysis part 234a collects N-past profile data which were stored the last, for instance, the number of the user's past service use behaviors and the user's past service use time. (a) of FIG. 15 is a table showing the collected past profile data according to the present invention.

Moreover, as shown in FIG. 14, based on the collected N-past profile data, the entire use behavior analysis part 234a generates a regression line (S90-20). In this instance, the regression line is generated referring to the following Equation 2.

$$y = {a}_{0} + {a}_{1} x \\ {a}_{1} = \frac{n {\sum }_{i = 1}^{n} {x}_{i} {y}_{i} - {\sum }_{i = 1}^{n} {x}_{i} {\sum }_{i = 1}^{n} {y}_{i}}{n {\sum }_{i = 1}^{n} {x}_{i}^{2} - {( {\sum }_{i = 1}^{n} {x}_{i} )}^{2}} \\ {a}_{0} = \frac{{\sum }_{i = 1}^{n} {y}_{i}}{n} - {a}_{1} \frac{{\sum }_{i = 1}^{n} {x}_{i}}{n} , \qquad [ Equation 2 ]$$

In the above equation, n means the number of profiles of a user to whom regression analysis will be applied.

Furthermore, the entire use behavior analysis part 234a obtains an average residual r based on the generated regression line, for instance, y=a₀+a₁x, and sets a normal range of the residual (rᵢ), for instance, |rᵢ|>|r| (S90-30). Additionally, through regression analysis using the generated regression line, the present service use speed is compared with the past service use speed (S90-40).

The entire use behavior analysis part 234a obtains the residual rᵢ between the present service use speed and the past service use speed, and checks whether or not the residual belongs to the normal range |rᵢ|>|r|. (b) of FIG. 15 is a graph showing a regression line of the profile data table illustrated in (a) of FIG. 15. Through the graph shown in (b) of FIG. 15, the residual rᵢ between the present service use speed and the past service use speed can be checked.

If the residual rᵢ belongs to the normal range |rᵢ|>|r|, the entire use behavior analysis part 234a judges the present user's use behavior as normality. However, if the residual rᵢ does not belong to the normal range |rᵢ|>|r|, the entire use behavior analysis part 234a judges the present user's use behavior as abnormality.

Through the second analysis of the entire use behavior (S90-10 to S90-40), if the present user's use behavior is judged as normality, the abnormal behavior detection module 236 generates a detection result of normal behavior and generates the corresponding profile (S70 to S85).

As a result of the second analysis, if the present user's use behavior is judged as abnormality, as shown in FIG. 7, the abnormal behavior detection module 236 generates a detection result of abnormality (S96), and then, transfers the generated detection result (of normal behavior or abnormal behavior) to the control system 300 (S98). The generated profile information is transferred to the profile managing part 250.

The abnormal behavior detection system 200 according to the present invention may be implemented in a recording medium which is readable by a computer using software, hardware or combination of the software and the hardware.

In order to implement the abnormal behavior detection system 200 into a hardware type, the abnormal behavior detection system 200 may be implemented using at least one of ASICs (Application Specific Integrated Circuits), DSPs (Digital Signal Processors), DSPDs (Digital Signal Processing Devices), PLDs (Programmable Logic Devices), FPGAs (Field Programmable Gate Arrays), processors, controllers, micro-controllers, microprocessors and electrical parts for performing functions. As occasion demands, the abnormal behavior detection system 200 according to the present invention may be implemented by itself.

While the present invention has been particularly shown and described with reference to the example embodiments thereof, it will be understood by those of ordinary skill in the art that the above embodiments of the present invention are all exemplified and various changes and equivalences may be made therein and that all or some of the example embodiments may be combined selectively. Therefore, it would be understood that the technical and protective scope of the present invention shall be defined by the technical idea as defined by the following claims and the equivalences.

As described above, differently from the existing network-based security equipment using network traffic analysis, the abnormal behavior detection system according to the present invention patterns behaviors based on various behavior elements of an object, such as time, location, connection network, used devices and so on in order to detect an abnormal behavior.

In order to enhance system security in the BYOD and smart work environment, the abnormal behavior detection system according to the present invention carries out the first analysis, which process situation information into connection, use and agent situation information and profile information and analyzes the entire use behavior pattern during the personalized connection period, and the second analysis based on service access speed to enhance capability for detecting an abnormal behavior.

In order to detect an abnormal access/use behavior, the abnormal behavior detection system according to the present invention utilizes possible atypical data on a business scenario, such as a type of a used device, connection period (for instance, on-duty hours and off-hours), access location (inside the company and outside the company), and a use period of time, as a user behavior pattern, thereby enhancing system security in the BYOD and smart work environment.

What is claimed is:

1. An abnormality detection part of an abnormal behavior detection system which analyzes the frequency of behaviors in the same connection situation occurring during the entire connection period through pattern analysis of use behaviors of the entire connection period in order to detect an abnormal behavior when predetermined situation information is received from a situation information collection system in a BYOD (Bring Your Own Device) and smart work environment, the abnormality detection part comprising:
an abnormal behavior analysis module which carries out ‘detection of variation of the entire behavior item’ and ‘detection of variation of an individual behavior item’ using the frequency of use behaviors during the present connection and the average of use behaviors during the past connection through the use behavior pattern analysis procedures of the entire connection period in order to analyze whether use of web service is abnormal or not;
a detection demand classifying module which classifies received detection demand messages and transfers the classified messages to each analysis part of the abnormal behavior analysis module; and
an abnormal behavior detection module which generates information on a detection result of normality or abnormality when the analysis result of the abnormal behavior analysis module is stored and which transfers the generated information to a control system,
wherein the abnormal behavior analysis module includes an entire use behavior analysis part which carries out the first analysis for analyzing a use behavior pattern during the entire connection period and carries out the second analysis based on service use speed when the first analysis generates a result value of suspicion.

2. The abnormality detection part according to claim 1, wherein the entire use behavior analysis part includes:
a first entire use behavior analysis part which carries out the first analysis for analyzing a pattern of the entire use behavior during the connection period; and
a second entire use behavior analysis part which carries out the second analysis based on service use speed if the first entire use behavior analysis part outputs a result value of suspicion.

3. The abnormality detection part according to claim 2, wherein the first entire use behavior analysis part includes:
a use behavior inquiry part for inquiring use processing information;
a first frequency analysis part for detecting the frequency of use behaviors occurring during the entire connection period from the present processing information;
a profile inquiry part for inquiring the corresponding user's past profile information;
a second frequency analysis part for detecting the frequency of the user's behaviors in the same connection situation as the past; and
a use behavior comparing part which calculates an error value by each behavior and judges whether or not the present user's use behavior is abnormal according to the calculated error value in order to carry out the ‘variation detection of the entire behavior item’, and judges whether or not the present user's use behavior is abnormal using the variation by individual behavior item in order to carry out the ‘variation detection of individual behavior item’.

4. The abnormality detection part according to claim 2, wherein the second entire use behavior analysis part includes:
a detection part for detecting the number of times of service use which detects the number of the present user's service use behaviors;
a service use time detection part which detects the present user's service use time;
an inquiry part for inquiring the number of times of past service use which loads the profile data stored in the storing part and detects the number of the user's past service use behaviors;
a past service use time detection part which loads the profile data stored in the storing part and detects the user's past service use time; and
a use behavior analysis part which compares the present service use speed with the past service use speed through regression analysis and judges whether or not the present user's use behavior is normal.

5. The abnormality detection part according to claim 4, wherein the use behavior analysis part includes:
a data collection part which collects N-past profile data;
a regression line generating part which generates a regression line related with the collected profile data in order to analyze the user's use speed;
a normal range setting part which obtains an average residual based on the generated regression line, and sets a normal range of the residual between the present service use speed and the past service use speed;
a use speed comparing part which obtains a residual and checks whether or not the residual belongs to the normal range; and
a normality judging part which judges the present user's use behavior as normality or abnormality according to whether or not the residual belongs to the normal range.

6. The abnormality detection part according to claim 5, wherein the regression line generating part generates a regression line referring to the following equation:
y=a₀+a₁x
$${a}_{1} = \frac{n {\sum }_{i = 1}^{n} {x}_{i} {y}_{i} - {\sum }_{i = 1}^{n} {x}_{i} {\sum }_{i = 1}^{n} {y}_{i}}{n {\sum }_{i = 1}^{n} {x}_{i}^{2} - {( {\sum }_{i = 1}^{n} {x}_{i} )}^{2}} {a}_{0} = \frac{{\sum }_{i = 1}^{n} {y}_{i}}{n} - {a}_{1} \frac{{\sum }_{i = 1}^{n} {x}_{i}}{n} ,$$
wherein n means the number of profiles of a user to whom regression analysis will be applied.

7. An abnormal behavior detection method of an abnormal behavior detection part which analyzes the frequency of behaviors in the same connection situation occurring during the entire connection period through pattern analysis of use behaviors of the entire connection period in order to detect an abnormal behavior when predetermined situation information is received from a situation information collection system in a BYOD (Bring Your Own Device) and smart work environment, the abnormal behavior detection method comprising:
a process that a detection demand classifying module classifies received detection demand messages and transfers the classified messages to each analysis part of an abnormal behavior analysis module;
a process that the abnormal behavior analysis module carries out ‘detection of variation of the entire behavior item’ and ‘detection of variation of an individual behavior item’ using the frequency of use behaviors during the present connection and the average of use behaviors during the past connection through the first analysis of the entire use behaviors for analyzing a pattern of use behaviors of the entire connection period, so as to analyze whether use of web service is abnormal or not; and
a process that an abnormal behavior detection module generates information on a detection result of normality or abnormality when the analysis result of the abnormal behavior analysis module is stored and transfers the generated information to a control system,
wherein the abnormal behavior analysis module carries out the second analysis based on service use speed when the first analysis of the entire use behavior generates a result value of suspicion.

8. The abnormal behavior detection method according to claim 7, wherein the first analysis process of the entire use behavior includes:
a process that a use behavior inquiry part inquires use processing information;
a process that a first frequency analysis part detects the frequency of use behaviors occurring during the entire connection period from the present processing information;
a process that a profile inquiry part inquires the corresponding user's past profile information;
a process that a second frequency analysis part detects the frequency of the user's behaviors in the same connection situation as the past; and
a process that a use behavior comparing part calculates an error value by each behavior and judges whether or not the present user's use behavior is abnormal according to the calculated error value in order to carry out the ‘variation detection of the entire behavior item’, and judges whether or not the present user's use behavior is abnormal using the variation by individual behavior item in order to carry out the ‘variation detection of individual behavior item’.

9. The abnormal behavior detection method according to claim 8, wherein the first analysis process of the entire use behavior includes:
a process that a detection part for detecting the number of times of service use detects the number of the present user's service use behaviors;
a process that a service use time detection part detects the present user's service use time;
a process that an inquiry part for inquiring the number of times of past service use loads the profile data stored in the storing part and detects the number of the user's past service use behaviors;
a process that a past service use time detection part loads the profile data stored in the storing part and detects the user's past service use time; and
a process that a use behavior analysis part compares the present service use speed with the past service use speed through regression analysis and judges whether or not the present user's use behavior is normal.

10. The abnormal behavior detection method according to claim 8, wherein the process that the use behavior analysis part judges whether or not the present user's use behavior is normal includes:
a process that a data collection part collects N-past profile data;
a process that a regression line generating part generates a regression line related with the collected profile data in order to analyze the user's use speed;
a process that a normal range setting part obtains an average residual based on the generated regression line, and sets a normal range of the residual between the present service use speed and the past service use speed;
a process that a use speed comparing part obtains a residual and checks whether or not the residual belongs to the normal range; and
a process that a normality judging part judges the present user's use behavior as normality or abnormality according to whether or not the residual belongs to the normal range.

11. The abnormal behavior detection method according to claim 10, wherein the process of generating a regression line generates a regression line related with the profile data referring to the following equation:
$$y = {a}_{0} + {a}_{1} x$$
$${a}_{1} = \frac{n {\sum }_{i = 1}^{n} {x}_{i} {y}_{i} - {\sum }_{i = 1}^{n} {x}_{i} {\sum }_{i = 1}^{n} {y}_{i}}{n {\sum }_{i = 1}^{n} {x}_{i}^{2} - {( {\sum }_{i = 1}^{n} {x}_{i} )}^{2}} {a}_{0} = \frac{{\sum }_{i = 1}^{n} {y}_{i}}{n} - {a}_{1} \frac{{\sum }_{i = 1}^{n} {x}_{i}}{n} ,$$
wherein n means the number of profiles of a user to whom regression analysis will be applied.
